(19) United States
(12) Patent Application Publication
(10) Pub. No.: US 2015/0254563 A1
(43) Pub. Date: Sep. 10, 2015

(54) DETECTING EMOTIONAL STRESSORS IN NETWORKS

(71) Applicant: International Business Machines Corporation, Armonk, NY (US)

(72) Inventors: Timothy M. Lynar, Kew (AU); Suraj Pandey, Carlton (AU); John M. Wagner, Plainville, CT (US)

(73) Assignee: International Business Machines Corporation, Armonk, NY (US)

(21) Appl. No.: 14/200,233

(22) Filed: Mar. 7, 2014

(51) Int. Cl. G06N 5/04; H04L 29/08

(52) U.S. Cl. CPC G06N 5/04; H04L 67/10

(57) ABSTRACT

A method for detecting an emotional stressor in a network includes detecting changes in emotions of users of the network, correlating individual ones of the changes in emotions, in accordance with a map that illustrates spatial, social, or temporal connections of the users, and inferring a cause of at least one of the changes in emotion, based on the correlating. A computer program product for detecting an emotional stressor in a network comprises a computer readable storage medium having program instructions embodied therewith. The program instructions are executable by a processor to cause the processor to perform a method including detecting changes in emotions of users of the network, correlating individual ones of the changes in emotions, in accordance with a map that illustrates spatial, social, or temporal connections of the users, and inferring a cause of at least one of the changes in emotion, based on the correlating.

### FIELD OF THE DISCLOSURE

The present disclosure relates generally to predictive analytics and relates more specifically to detecting changes in collective stress.

### BACKGROUND OF THE DISCLOSURE

There are many instances in which it may be advantageous to detect spatial, social, and/or temporal changes in emotion (such as changes in collective stress) present among people in an environment. For instance, information about such changes could be provided to a predictive engine that identifies how individuals affect one another, the strength of the effects, and/or the distance traveled by those effects within a social network. The information could also be used to gauge the effectiveness of advertisements or the effects of specific events. Additionally, the information could be used to identify sources of socially malicious or aggressive behavior (e.g., bullying) within a network.

### SUMMARY OF THE DISCLOSURE

A method for detecting an emotional stressor in a network includes detecting changes in emotions of users of the network, correlating individual ones of the changes in emotions, in accordance with a map that illustrates spatial, social, or temporal connections of the users, and inferring a cause of at least one of the changes in emotion, based on the correlating.

A computer program product for detecting an emotional stressor in a network comprises a computer readable storage medium having program instructions embodied therewith. The program instructions are executable by a processor to cause the processor to perform a method including detecting changes in emotions of users of the network, correlating individual ones of the changes in emotions, in accordance with a map that illustrates spatial, social, or temporal connections of the users, and inferring a cause of at least one of the changes in emotion, based on the correlating.

A system for detecting an emotional stressor in a network includes a plurality of endpoint devices for supporting interactions of the users via the network, a database for storing data relating to emotions of the users, wherein the data is extracted from the interactions, and an application server for detecting changes in the emotions, correlating individual ones of the changes in emotions, in accordance with a map that illustrates spatial, social, or temporal connections of the users, and inferring a cause of at least one of the changes in emotion, based on the correlating.

### BRIEF DESCRIPTION OF THE DRAWINGS

The teachings of the present disclosure can be readily understood by considering the following detailed description in conjunction with the accompanying drawings, in which:

FIG. 1 is a block diagram depicting one example of a communications network;

FIG. 2 is a flow diagram illustrating one embodiment of a method for detecting emotional stressors in a network, according to the present invention; and

FIG. 3 is a high level block diagram of the present invention implemented using a general purpose computing device.

To facilitate understanding, identical reference numerals have been used, where possible, to designate identical elements that are common to the Figures.

### DETAILED DESCRIPTION

In one embodiment, the present invention is a method and apparatus for detecting emotional stressors in networks. Embodiments of the invention detect spatial, social, and/or temporal changes in collective stress on individuals using networked devices (e.g., smart phones), video feeds, access devices, online services (social networking services), and the like. For instance, embodiments of the invention may be implemented to identify and localize causes of adverse emotional changes. Detection of this information allows networks or organizations to provide a degree of safety against threats such as cyber-bullying.

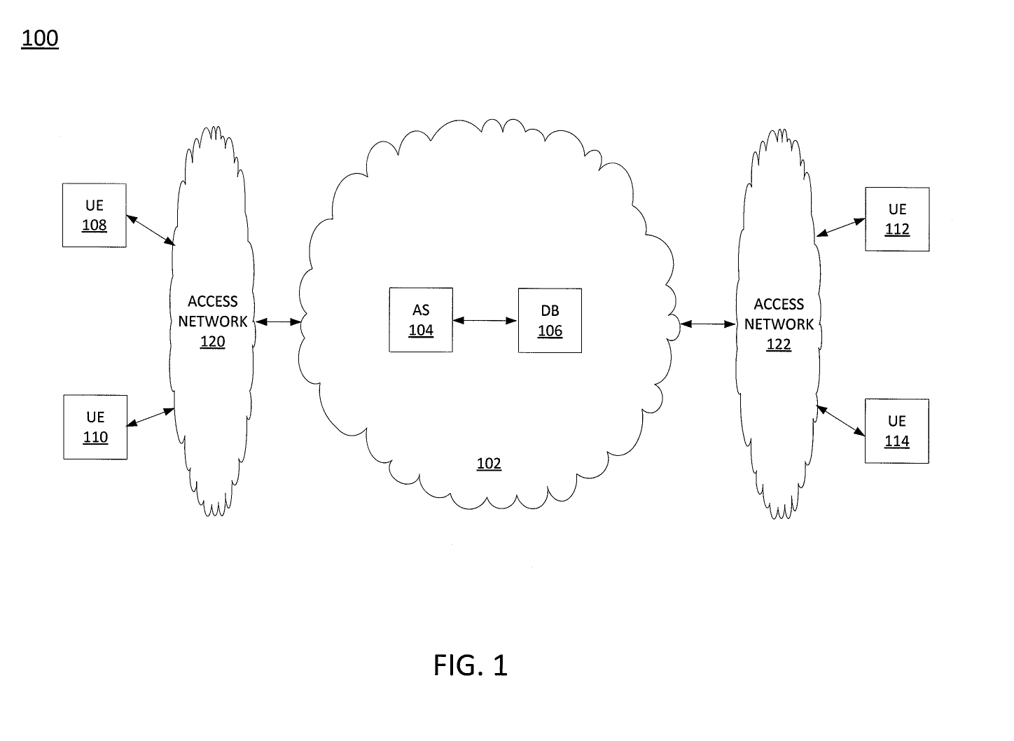

FIG. 1 is a block diagram depicting one example of a communications network 100. The communications network 100 may be any type of communications network, such as for example, a traditional circuit switched network (e.g., a public switched telephone network (PSTN)) or an Internet Protocol (IP) network (e.g., an IP Multimedia Subsystem (IMS) network, an asynchronous transfer mode (ATM) network, a wireless network, a cellular network (e.g., 2G, 3G and the like), a long term evolution (LTE) network, and the like) related to the current disclosure. It should be noted that an IP network is broadly defined as a network that uses Internet Protocol to exchange data packets. Additional exemplary IP networks include Voice over IP (VoIP) networks, Service over IP (SoIP) networks, and the like.

In one embodiment, the network 100 may comprise a core network 102. The core network 102 may be in communication with one or more access networks 120 and 122. The access networks 120 and 122 may include a wireless access network (e.g., a WiFi network and the like), a cellular access network, a PSTN access network, a cable access network, a wired access network and the like. In one embodiment, the access networks 120 and 122 may all be different types of access networks, may all be the same type of access network, or some access networks may be the same type of access network and other may be different types of access networks. The core network 102 and the access networks 120 and 122 may be operated by different service providers, the same service provider or a combination thereof.

In one embodiment, the core network 102 may include an application server (AS) 104 and a database (DB) 106. Although only a single AS 104 and a single DB 106 are illustrated, it should be noted that any number of application servers 104 or databases 106 may be deployed.

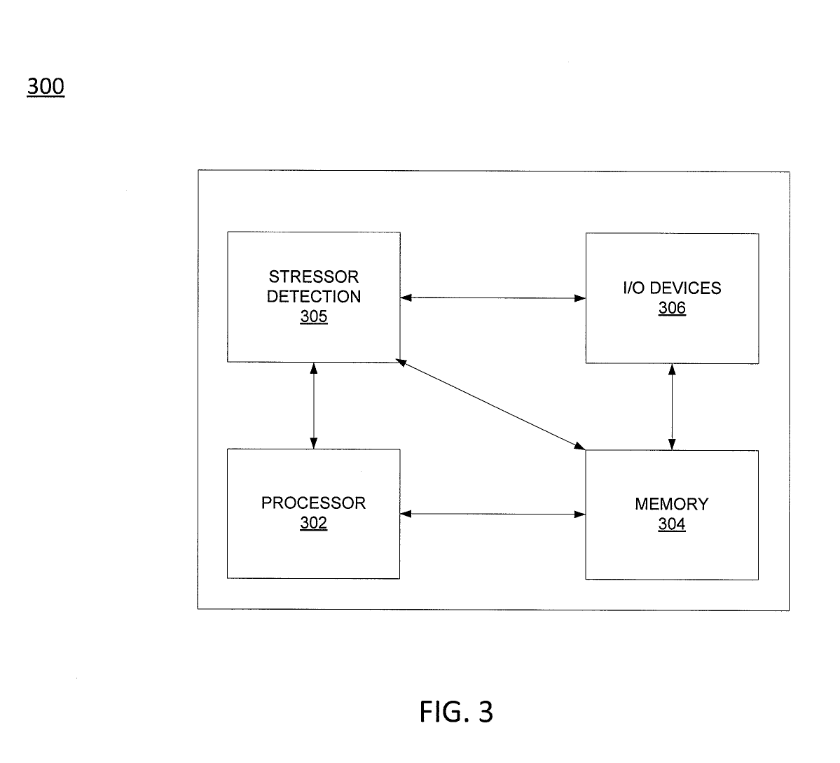

In one embodiment, the AS 104 may comprise a general purpose computer as illustrated in FIG. 3 and discussed below. In one embodiment, the AS 104 may perform the methods and algorithms discussed below related to detecting emotional stressors in networks.

In one embodiment, the DB 106 may store maps of individuals who are connected to each other (spatially, socially, and/or temporarily). The DB 106 may also store values indicating detected emotions and changes in emotions for one or more of these individuals.

In one embodiment, the access network 120 may be in communication with one or more user endpoint devices (also referred to as “endpoint devices” or “UE”) 108 and 110. In one embodiment, the access network 122 may be in communication with one or more user endpoint devices 112 and 114.

In one embodiment, the user endpoint devices 108, 110, 112 and 114 may be any type of mobile device such as a cellular telephone, a smart phone, a tablet computer, a laptop computer, a netbook, an ultrabook, a portable media device (e.g., an MP3 player), a gaming console, a portable gaming device, and the like. It should be noted that although only four user endpoint devices are illustrated in FIG. 1, any number of user endpoint devices may be deployed.

It should be noted that the network 100 has been simplified. For example, the network 100 may include other network elements (not shown) such as border elements, routers, switches, policy servers, security devices, a content distribution network (CDN) and the like.

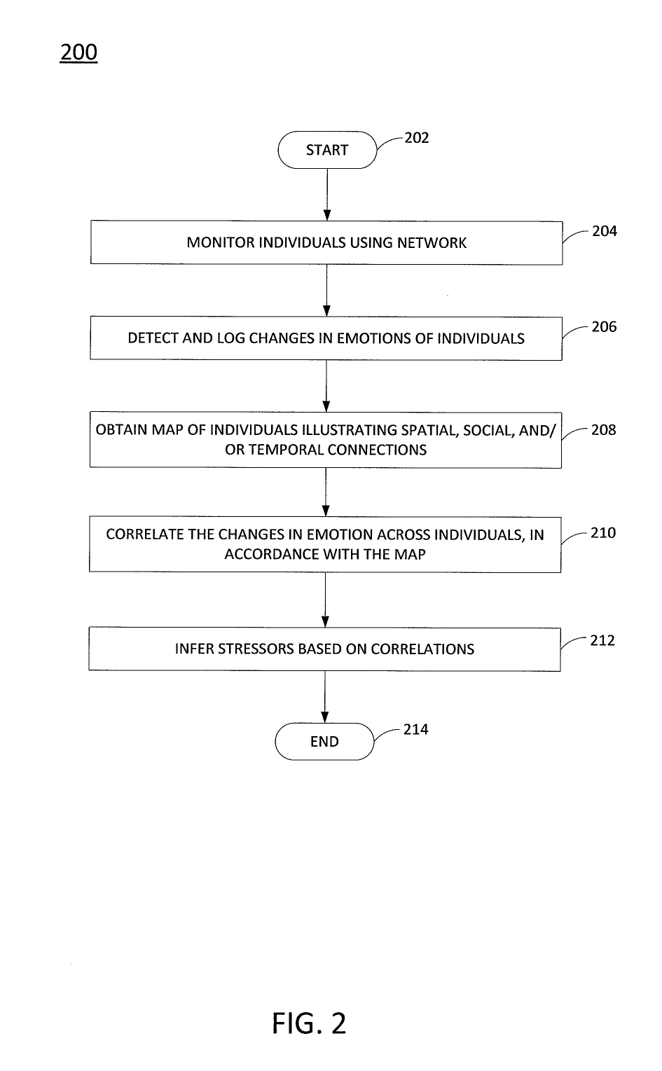

FIG. 2 is a flow diagram illustrating one embodiment of a method 200 for detecting emotional stressors in a network, according to the present invention. In one embodiment, the method 200 may be performed by the application server (AS) 104 illustrated in FIG. 1. As such, reference is made in the discussion of the method 200 to various elements of the network 100 illustrated in FIG. 1. However, it will be appreciated that the method 200 is not limited to implementation within the network 100, and may, in fact, be implemented in networks and systems having configurations that differ from that illustrated.

The method 200 begins in step 202. In step 204, the AS 104 monitors individuals using the network 100. These individuals may comprise, for example, users of user endpoint devices 108, 110, 112 and 114. The monitoring may include observing user interactions involving voluntarily obtrusive devices, such as smart phones and computers (e.g., via sensors embedded in the devices). The monitoring may also include observing user behaviors involving non-obtrusive devices and activities, such as video feeds and smart cards (e.g., such as those used to physically access facilities and resources). In addition, the monitoring may include observing online data, such as data obtained from social networks, blogs, or the like.

In step 206, the AS 104 detects and logs a change in the emotion of at least one of the individuals. There is a variety of ways in which such a change in emotion may be detected. For instance, changes in various observable physiological indicators (e.g., blood pressure, heart rate, breathing rate or volume, pupil dilation, skin conductivity, flushed or blanched skin, speech characteristics such as tone or volume, facial expressions, involuntary muscular contraction such as tremors or shudders, crying, etc.) can indicate corresponding changes in emotion. These physiological indicators can be monitored via one or more sensors in the user endpoint devices 108, 110, 112 and 114. In one embodiment, any detected emotion is quantified in some manner, in order to gauge the extent of any change it may experience.

In step 208, the AS 104 obtains a map of the individuals. The map indicates the spatial, social, and/or temporal connections between the individuals. For instance, individuals may be placed in positions on the map that correspond to the individuals' present emotional states, contexts of emotion, and/or history of emotional changes with time. Alternatively, individuals may be placed in positions on the map that correspond to the individuals' current roles in some social structure (e.g., trend setters, potential impact bearers, etc.). These positions may be based in part on the individuals' distances relative to a collective emotional measure and/or to relative to links within and across social networks. Individuals may also be placed in positions on the map that correspond to the magnitudes of the impacts the individuals have in a temporal domain. In another scenario, individuals may be placed in positions on the map that simultaneously correspond to the individuals' current spatial (geographic), social, and temporal statuses. In this case, the map positions may be associated with some measurable degree of certainty that identifies the individual as a human or non-human (e.g., machine) entity. The map obtained in step 208 may be created by the AS 104 or obtained by the AS 104 from some other source.

In step 210, the AS 104 correlates the changes in emotion that were detected in step 206 across the individuals, in accordance with the map. That is, the AS 104 identifies relationships between the individual changes in emotion, guided by contextual information about the associated individuals(s) (which may be obtained from the map). For instance, the AS 104 may correlate the emotions of a single individual over time and/or network domains. The AS 104 may also correlate the emotions of multiple individuals within a network and/or across networks. In addition, the AS 104 may correlate an emotion across dynamic boundaries of an emotion-based map. In one embodiment, a confidence in these correlations may be quantified.

In step 212, the AS 104 infers one or more stressors based on the correlations identified in step 210. That is, the AS 104 identifies the probable causes of observed changes in the emotions of individuals or groups of individuals. These causes may be human or non-human (e.g., machine). In one embodiment, inferred stressors are quantified and classified in measurable levels (e.g., according to their impacts on individuals or groups of individuals).

FIG. 3 is a high level block diagram of the present invention implemented using a general purpose computing device 300. In one embodiment, the general purpose computing device 300 is deployed as a user endpoint device, such as the user endpoint device 108, 110, 112, or 114 illustrated in FIG. 1. In another embodiment, the general purpose computing device 300 is deployed as a server, such as the application server 104 illustrated in FIG. 1. It should be understood that embodiments of the invention can be implemented as a physical device or subsystem that is coupled to a processor through a communication channel. Therefore, in one embodiment, a general purpose computing device 300 comprises a processor 302, a memory 304, a stressor detection module 305, and various input/output (I/O) devices 306 such as a display, a keyboard, a mouse, a modem, a microphone, speakers, a touch screen, an adaptable I/O device, and the like. In one embodiment, at least one I/O device is a storage device (e.g., a disk drive, an optical disk drive, a floppy disk drive). In another embodiment, at least one I/O device is a sensor (e.g., a slip sensor, a touch sensor, a tactile sensor, a temperature sensor, a noise sensor, a light sensor, an accelerometer, a gyroscope, an altimeter, or the like).

Alternatively, embodiments of the present invention (e.g., stressor detection module 305) can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the stressor detection module 305 for detecting emotional stressors in networks described herein with reference to the preceding Figures can be stored on a tangible or non-transitory computer readable medium (e.g., RAM, magnetic or optical drive or diskette, and the like).

Referring to FIG. 3, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although various embodiments which incorporate the teachings of the present invention have been shown and described in detail herein, those skilled in the art can readily devise many other varied embodiments that still incorporate these teachings.

What is claimed is:

1. A method for detecting an emotional stressor in a network, the method comprising:
detecting changes in emotions of users of the network;
correlating individual ones of the changes in emotions, in accordance with a map that illustrates spatial, social, or temporal connections of the users; and
inferring a cause of at least one of the changes in emotion, based on the correlating.

2. The method of claim 1, wherein the detecting comprises:
monitoring endpoint devices used by the users and connected to the network.

3. The method of claim 2, wherein the monitoring comprises:
observing interactions of the users involving voluntarily obtrusive devices.

4. The method of claim 2, wherein the monitoring comprises:
observing behaviors of the users involving non-obtrusive devices and activities.

5. The method of claim 2, wherein the monitoring comprises:
observing online data.

6. The method of claim 1, wherein the changes in emotions are detected via changes in an observable physiological indicator.

7. The method of claim 6, wherein the observable physiological indicator is a blood pressure of one of the users.

8. The method of claim 6, wherein the observable physiological indicator is a heart rate of one of the users.

9. The method of claim 6, wherein the observable physiological indicator is a pupil dilation of one of the users.

10. The method of claim 6, wherein the observable physiological indicator is a skin conductivity of one of the users.

11. The method of claim 1, wherein the map places the users in positions that correspond to present emotional states of the users.

12. The method of claim 1, wherein the map places the users in positions that correspond to emotional contexts of the users.

13. The method of claim 1, wherein the map places the users in positions that correspond to historical emotional changes of the users.

14. The method of claim 1, wherein the map places the users in positions that correspond to current roles of the users in a social structure.

15. The method of claim 1, wherein the map places the users in positions that correspond to magnitudes of impacts made by the users in a temporal domain.

16. The method of claim 1, wherein the map places the users in positions that correspond to current spatial, social, or temporal statuses of the users.

17. The method of claim 1, wherein the correlating comprises:
identifying a relationship among a subset of the changes in emotion that are associated with a single individual.

18. The method of claim 1, wherein the correlating comprises:
identifying a relationship between a first one of the changes in emotion that is associated with a first one of the users and a second one of the changes in emotion that is associated with a second one of the users.

19. A computer program product for detecting an emotional stressor in a network, the computer program product comprising a computer readable storage medium having program instructions embodied therewith, the program instructions executable by a processor to cause the processor to perform a method comprising:
detecting changes in emotions of users of the network;
correlating individual ones of the changes in emotions, in accordance with a map that illustrates spatial, social, or temporal connections of the users; and
inferring a cause of at least one of the changes in emotion, based on the correlating.

20. A system for detecting an emotional stressor in a network, the system comprising:
a plurality of endpoint devices for supporting interactions of the users via the network;
a database for storing data relating to emotions of the users, wherein the data is extracted from the interactions; and
an application server for detecting changes in the emotions, correlating individual ones of the changes in emotions, in accordance with a map that illustrates spatial, social, or temporal connections of the users, and inferring a cause of at least one of the changes in emotion, based on the correlating.
